(19) United States
(12) Patent Application Publication
(10) Pub. No.: US 2016/0059482 A1
(43) Pub. Date: Mar. 3, 2016

(54) APPARATUS FOR MODELING THREE-DIMENSIONAL OBJECT AND METHOD FOR MODELING THREE-DIMENSIONAL OBJECT

(71) Applicant: MIMAKI ENGINEERING CO., LTD., NAGANO (JP)

(72) Inventors: KUNIO HAKKAKU, NAGANO (JP); SHUMPEI KURIHARA, NAGANO (JP)

(21) Appl. No.: 14/830,720

(22) Filed: Aug. 19, 2015

(30) Foreign Application Priority Data
Aug. 27, 2014 (JP) 2014-172497

(51) Int. Cl. B29C 67/00

(52) U.S. Cl. CPC B29C 67/0007; B29L 2009/00

(57) ABSTRACT

An apparatus for modeling a three-dimensional object configured to model a three-dimensional object by a lamination modeling method includes a head for coloring, a head for modeling, a pair of flattening rollers and a main scanning driving unit. The main scanning driving unit is configured to enable at least the head for modeling to perform a main scanning operation in a first direction, which is one side direction of a main scanning direction, and at least the head for coloring to perform the main scanning operation in a second direction, which is the other side direction of the main scanning direction. The one flattening roller of the pair of flattening rollers flattens the three-dimensional object being modeled when the main scanning operation in the first direction is performed, and the other flattening roller flattens the three-dimensional object being modeled when the main scanning operation in the second direction is performed.

### CROSS-REFERENCE TO RELATED APPLICATION

This application claims the priority benefit of Japan application serial no. 2014-172497, filed on Aug. 27, 2014. The entirety of the above-mentioned patent application is hereby incorporated by reference herein and made a part of specification.

### TECHNICAL FIELD

The present disclosure relates to an apparatus for modeling a three-dimensional object and a method for modeling a three-dimensional object.

### DESCRIPTION OF THE BACKGROUND ART

In recent years, a 3D printer configured to model a three-dimensional (3D) object has been gradually distributed. Also, in the related art, a variety of methods as regards a method for modeling a three-dimensional object by an apparatus for modeling a three-dimensional object such as 3D printer have been suggested. For example, in the related art, a method of removing an extra part of a modeling material to flatten a surface of the modeling material by a roller has been suggested (for example, refer to Patent Document 1).

[Patent Document 1] JP-A-2012-96427

### SUMMARY

However, at present, it cannot be said that the modeling method of the 3D printer and the like is completely established. For this reason, there is a need for a method capable of more appropriately modeling a three-dimensional object from various standpoints. Therefore, the present disclosure provides an apparatus for modeling a three-dimensional object and a method for modeling a three-dimensional object capable of solving the above problem.

The inventors extensively studied on a method for modeling a three-dimensional object. First, the inventors conducted various studies on a configuration of adopting a roller (flattening roller) configured to flatten a three-dimensional object being modeled when modeling the three-dimensional object by a lamination modeling method. When the flattening roller is used, it is possible to flatten an ink layer formed as a laminated modeling layer, thereby modeling a three-dimensional object with higher precision.

Here, when modeling the three-dimensional object by the lamination modeling method, an inkjet head configured to eject ink droplets becoming a modeling material is used, for example, and the inkjet head is enabled to perform a main scanning operation and to form an ink layer. Also, in this case, in order to reduce the time necessary for the modeling, it is considered to enable the inkjet head to perform a reciprocal (bidirectional) main scanning operation and to form ink layers by the respective main scanning operations in forward and backward directions.

In the above configuration, when the flattening roller is simply used in the same manner as the related art, the flattening is performed only during one main scanning operation of the reciprocal main scanning operation. However, in order to model a three-dimensional object with higher precision, it is preferably to perform the flattening during the main scanning operations in both the forward and backward directions.

Meanwhile, in order to model a three-dimensional object with high precision, it is also considered to perform the main scanning direction only in the one direction (single direction) without performing the reciprocal main scanning operation. However, in this case, the time necessary for the modeling is remarkably increased. Also, it is usually required to reduce the time necessary for the modeling as much as possible. For this reason, the configuration of performing the main scanning operation only in the one direction is not needed depending on the using applications.

Regarding the above problem, the inventors found, after having extensively studied on the configuration of using the flattening roller, a configuration capable of modeling a three-dimensional object more appropriately. Also, as described later, the inventors found a configuration capable of modeling a three-dimensional object more appropriately, in addition to the configuration of using the flattening roller. That is, the present disclosure has following configurations so as to solve the above problems.

(Configuration 1) There is provided an apparatus for modeling a three-dimensional object configured to model a three-dimensional object by a lamination modeling method. The apparatus includes a head for coloring, which is an inkjet head configured to form an area of the three-dimensional object, which is to be colored with a predetermined color, by an ink for coloring; a head for modeling, which is an inkjet head configured to form at least an inner area of the three-dimensional object; at least a pair of flattening rollers configured to flatten the three-dimensional object being modeled, and a main scanning driving unit configured to enable the head for coloring and the head for modeling to perform a main scanning operation of ejecting ink droplets while moving in a preset main scanning direction. The main scanning driving unit is configured to enable at least the head for modeling to perform the main scanning operation in a first direction, which is one side direction of the main scanning direction, and at least the head for coloring to perform the main scanning operation in a second direction, which is the other side direction of the main scanning direction. The one flattening roller of the pair of flattening rollers flattens the three-dimensional object being modeled when the main scanning operation in the first direction is performed, and the other flattening roller of the pair of flattening rollers flattens the three-dimensional object being modeled when the main scanning operation in the second direction is performed.

In the above configuration, the second direction is an opposite direction to the first direction, for example. More specifically, the first direction and the second direction may be one and the other of a forward direction and a backward direction in a reciprocal main scanning operation. Also, the description ‘flattening the three-dimensional object being modeled’ means flattening an ink layer of ink layers sequentially formed by the lamination modeling method, which is positioned at the uppermost part, for example. Also, the flattening roller is configured to scrape a part of the ink layer, thereby flattening the ink layer. The flattening roller may be a flattening roller configured to flatten the ink layer. Also, the apparatus for modeling a three-dimensional object may further have a separate flattening roller, in addition to the pair of flattening rollers.

According to the above configuration, it is possible to appropriately model a colored three-dimensional object, for example. Also, for example, during each main scanning operation in the first direction and the second direction, it is possible to appropriately perform the flattening operation. More specifically, for example, when performing the reciprocal main scanning operation, it is possible to appropriately perform the flattening operation during each main scanning operation in the forward direction and the backward direction. For this reason, by this configuration, it is possible to appropriately model the three-dimensional object with high precision without remarkably increasing the time necessary for the modeling, for example.

(Configuration 2) The head for coloring and the head for modeling are configured to eject ink droplets of an ultraviolet curable ink, which is to be cured by ultraviolet irradiation. By this configuration, for example, it is possible to appropriately mode the three-dimensional object by the lamination modeling method. The apparatus for modeling a three-dimensional object preferably has further an ultraviolet light source configured to irradiate ultraviolet.

(Configuration 3) The apparatus further includes a roller advance/retreat driving unit configured to advance and retreat each of the pair of flattening rollers in a direction facing towards the three-dimensional object. The roller advance/retreat driving unit is configured to arrange the one flattening roller of the pair of flattening rollers at an advanced position and to arrange the other flattening roller at a retreated position while the main scanning operation in the first direction is performed, and to arrange the other flattening roller at an advanced position and to arrange the one flattening roller at a retreated position while the main scanning operation in the second direction is performed.

During each main scanning operation in the first direction and the second direction, when performing the flattening, there may be a case where the flattening cannot be appropriately performed simply by using the pair of flattening rollers. For example, during the main scanning operation in the first direction, when the other flattening roller is contacted to an upper surface of the three-dimensional object being modeled, in addition to the one flattening roller, the flattening precision may be lowered due to an influence of the other flattening roller. Also, during the main scanning operation in the second direction, when the one flattening roller is contacted to the upper surface of the three-dimensional object being modeled, in addition to the other flattening roller, the flattening precision may be lowered due to an influence of the one flattening roller.

In contrast, according to the above configuration 3, it is possible to appropriately move the respective flattening rollers by using the roller advance/retreat driving unit, for example. Thereby, it is also possible to appropriately bring only one of the pair of flattening rollers into contact with the upper surface of the three-dimensional object being modeled during each main scanning operation. For this reason, by this configuration, it is possible to more appropriately perform the flattening with high precision during each main scanning operation in the first direction and the second direction, for example.

(Configuration 4) The roller advance/retreat driving unit is configured to advance the flattening roller, thereby bringing the flattening roller close to the three-dimensional object being modeled, and to retreat the flattening roller, thereby separating the flattening roller from the three-dimensional object being modeled. By this configuration, it is possible, for example, to move the flattening roller appropriately.

(Configuration 5) During the main scanning operation in the first direction, the main scanning driving unit is configured to enable only the head for modeling of the head for modeling and the head for coloring to eject the ink droplets and the one flattening roller is configured to flatten an ink layer formed by the head for modeling, and during the main scanning operation in the second direction, the main scanning driving unit is configured to enable only the head for coloring of the head for modeling and the head for coloring to eject the ink droplets and the other flattening roller is configured to flatten an ink layer formed by the head for coloring.

When modeling a colored three-dimensional object, when an ink for modeling (for example, dedicated ink for modeling, white ink and the like) and an ink for coloring (for example, color ink) are mixed, a blurring occurs, so that an outward appearance quality of the three-dimensional object may be deteriorated. Also, for example, when the flattening is performed by the flattening roller in a situation where the ink for modeling and the ink for coloring are at a liquid state, the blurring is likely to occur.

In contrast, according to the configuration 5, for example, the operation of modeling the three-dimensional object by the head for modeling and the operation of coloring the three-dimensional object by the head for coloring is capable of being performed during the separate main scanning operations. In this case, even when the flattening is performed during each main scanning operation, the flattening by the flattening roller is not performed in a situation where the ink for modeling and the ink for coloring are at a liquid state.

For this reason, according to the above configuration, it is possible to appropriately prevent the ink for modeling and the ink for coloring from being mixed due to the flattening operation. Thereby, it is also possible to appropriately model the three-dimensional object with high precision, for example.

(Configuration 6) During the main scanning operations in the first direction and the second direction, the main scanning driving unit is configured to enable both the head for modeling and the head for coloring to eject the ink droplets. By this configuration, it is possible to appropriately shorten the time required to form the three-dimensional object, for example.

(Configuration 7) The one flattening roller and the other flattening roller are configured to rotate in different rotating directions during the flattening. By this configuration, it is possible to appropriately rotate each flattening roller in correspondence to the direction of the main scanning operation in which the flattening is performed, for example.

(Configuration 8) The one flattening roller and the other flattening roller are configured to rotate at different rotating speeds during the flattening. By this configuration, it is possible to make the rotating speeds of the flattening rollers different in conformity to the configuration of the ink layer, which is to be formed during the main scanning operation in which the flattening is performed, for example. Thereby, it is also possible to more appropriately perform the flattening by using a setting corresponding to the configuration of the ink layer, for example.

(Configuration 9) The one flattening roller is arranged at one side in the main scanning direction with respect to the head for coloring and the head for modeling, and the other flattening roller is arranged at the other side in the main scanning direction with respect to the head for coloring and the head for modeling. During each of the main scanning operations in the first direction and the main scanning operation in the second direction, the flattening roller positioned at the rear with respect to the head for coloring and the head for modeling is configured to flatten the three-dimensional object being modeled. The rear with respect to the head for coloring and the head for modeling is an upstream side with respect to a moving direction during the main scanning operation, for example. By this configuration, it is possible to appropriately perform the flattening during each main scanning operation in the first direction and the second direction, for example.

(Configuration 10) The apparatus is configured to form a layer including a coloring layer, which is an ink layer to be formed by the head for coloring, and a modeling layer, which is an ink layer to be formed by the head for modeling, as each layer to be formed by the lamination modeling method. Upon the formation of each layer, the apparatus is configured to perform a first layer forming operation of forming one layer of the coloring layer and the modeling layer by using one of the head for coloring and the head for modeling, and a second layer forming operation of forming the other layer of the coloring layer and the modeling layer to be adjacent to a wall part of the one layer by using the other of the head for coloring and the head for modeling after curing the one layer.

According to the above configuration, it is possible to more appropriately prevent the ink for modeling and the ink for coloring from being mixed, for example. Thereby, it is also possible to more appropriately model the three-dimensional object with high precision, for example.

(Configuration 11) The apparatus further includes a head for support layer, which is an inkjet head configured to form a support layer configured to support a periphery of the three-dimensional object being modeled. The apparatus is configured to form a layer including a coloring layer, which is an ink layer to be formed by the head for coloring, a modeling layer, which is an ink layer to be formed by the head for modeling, and the support layer, which is an ink layer to be formed by the head for support layer, as each layer to be formed by the lamination modeling method. Upon the formation of each layer, the apparatus is configured to perform a first layer forming operation of forming the modeling layer and the support layer by using the head for modeling and the head for support layer, and a second layer forming operation of forming the coloring layer by using the head for coloring after the first layer forming operation. During the first layer forming operation, the modeling layer and the support layer are formed so as to sandwich an area, in which the coloring layer is later to be formed, between the modeling layer and the support layer, so that a wall part of the modeling layer is formed at one side of the area in which the coloring layer is to be formed and a wall part of the support layer is formed at the other side of the area in which the coloring layer is to be formed, and during the second layer forming operation, the coloring layer is formed between the wall part of the modeling layer and the wall part of the support layer.

According to the above configuration, it is possible to more appropriately prevent the ink for modeling and the ink for coloring from being mixed, for example. Thereby, it is also possible to more appropriately model the three-dimensional object with high precision, for example.

Also, according to the above configuration, after the first layer forming operation, the area in which the coloring layer is later to be formed becomes an area (recess portion) having a recess shape positioned between the wall part of the modeling layer and the wall part of the support layer. In this case, when forming the coloring layer in the second layer forming operation, the wall parts of the recess function as a guide. For this reason, according to the above configuration, it is possible to appropriately prevent a position of the coloring layer from deviating or the coloring layer from being obliquely formed, for example. Thereby, it is also possible to more appropriately form the colored three-dimensional object with high precision, for example.

(Configuration 12) There is provided an apparatus for modeling a three-dimensional object configured to model a three-dimensional object by a lamination modeling method. The apparatus includes a head for coloring, which is an inkjet head configured to form an area of the three-dimensional object, which is to be colored with a predetermined color, by an ink for coloring; a head for modeling, which is an inkjet head configured to form at least an inner area of the three-dimensional object; at least a pair of flattening rollers configured to flatten the three-dimensional object being modeled, and a main scanning driving unit configured to enable the head for coloring and the head for modeling to perform a main scanning operation of ejecting ink droplets while moving in a preset main scanning direction. One flattening roller of the pair of flattening rollers is arranged at one side in the main scanning direction with respect to the head for coloring and the head for modeling, and the other flattening roller of the pair of flattening rollers is arranged at the other side in the main scanning direction with respect to the head for coloring and the head for modeling. The main scanning driving unit is configured to enable at least the head for modeling to perform the main scanning operation in a first direction, which is one side direction of the main scanning direction, and at least the head for coloring to perform the main scanning operation in a second direction, which is the other side direction of the main scanning direction. During each of the main scanning operations in the first direction and the main scanning operation in the second direction, the flattening roller positioned at the rear with respect to the head for coloring and the head for modeling is configured to flatten the three-dimensional object being modeled.

According to the above configuration, it is possible, for example, to appropriately model the colored three-dimensional object. Also, according to the above configuration, it is possible to appropriately perform the flattening operation during each main scanning operation in the first direction and the second direction. For this reason, according to the above configuration, it is possible, for example, to appropriately model the three-dimensional object with high precision without remarkably increasing the time necessary for the modeling, for example.

(Configuration 13) There is provided an apparatus for modeling a three-dimensional object configured to model a three-dimensional object by a lamination modeling method. The apparatus includes a head for coloring, which is an inkjet head configured to form an area of the three-dimensional object, which is to be colored with a predetermined color, by an ink for coloring, and a head for modeling, which is an inkjet head configured to form at least an inner area of the three-dimensional object. The apparatus is configured to form a layer including a coloring layer, which is an ink layer to be formed by the head for coloring, and a modeling layer, which is an ink layer to be formed by the head for modeling, as each layer to be formed by the lamination modeling method. Upon the formation of each layer, the apparatus is configured to perform a first layer forming operation of forming one layer of the coloring layer and the modeling layer by using one of the head for coloring and the head for modeling, and a second layer forming operation of forming the other layer of the coloring layer and the modeling layer to be adjacent to a wall part of the one layer by using the other of the head for coloring and the head for modeling after curing the one layer.

According to the above configuration, it is possible to appropriately model the colored three-dimensional object. Also, for example, it is possible to appropriately prevent the ink for modeling and the ink for coloring from being mixed. Therefore, according to the above configuration, it is possible to appropriately model the three-dimensional object with high precision, for example.

(Configuration 14) There is provided an apparatus for modeling a three-dimensional object configured to model a three-dimensional object by a lamination modeling method. The apparatus includes a head for coloring, which is an inkjet head configured to form an area of the three-dimensional object, which is to be colored with a predetermined color, by an ink for coloring; a head for modeling, which is an inkjet head configured to form at least an inner area of the three-dimensional object, and a head for support layer, which is an inkjet head configured to form a support layer configured to support a periphery of a three-dimensional object being modeled. The apparatus is configured to form a layer including a coloring layer, which is an ink layer to be formed by the head for coloring, a modeling layer, which is an ink layer to be formed by the head for modeling, and the support layer, which is an ink layer to be formed by the head for support layer, as each layer to be formed by the lamination modeling method. Upon the formation of each layer, the apparatus is configured to perform a first layer forming operation of forming the modeling layer and the support layer by using the head for modeling and the head for support layer, and a second layer forming operation of forming the coloring layer by using the head for coloring after the first layer forming operation. During the first layer forming operation, the modeling layer and the support layer are formed so as to sandwich an area, in which the coloring layer is later to be formed, between the modeling layer and the support layer, so that a wall part of the modeling layer is formed at one side of the area in which the coloring layer is to be formed and a wall part of the support layer is formed at the other side of the area in which the coloring layer is to be formed, and during the second layer forming operation, the coloring layer is formed between the wall part of the modeling layer and the wall part of the support layer.

According to the above configuration, it is possible to appropriately model the colored three-dimensional object. Also, for example, it is possible to appropriately prevent the ink for modeling and the ink for coloring from being mixed.

Also, according to the above configuration, after the first layer forming operation, the area in which the coloring layer is later to be formed becomes an area (recess portion) having a recess shape positioned between the wall part of the modeling layer and the wall part of the support layer. In this case, when forming the coloring layer in the second layer forming operation, the wall parts of the recess function as a guide. For this reason, according to the above configuration, it is possible to appropriately prevent a position of the coloring layer from deviating or the coloring layer from being obliquely formed, for example. Thereby, it is also possible to more appropriately form the colored three-dimensional object with high precision, for example.

(Configuration 15) There is provided a method for modeling a three-dimensional object by a lamination modeling method. The method uses a head for coloring, which is an inkjet head configured to form an area of the three-dimensional object, which is to be colored with a predetermined color, by an ink for coloring; a head for modeling, which is an inkjet head configured to form at least an inner area of the three-dimensional object, and at least a pair of flattening rollers configured to flatten the three-dimensional object being modeled. The method includes enabling the head for coloring and the head for modeling to perform a main scanning operation of ejecting ink droplets while moving in a preset main scanning direction. When controlling the main scanning operation, the method includes enabling at least the head for modeling to perform the main scanning operation in a first direction, which is one side direction of the main scanning direction, and at least the head for coloring to perform the main scanning operation in a second direction, which is the other side direction of the main scanning direction. The method includes flattening the three-dimensional object being modeled by the one flattening roller of the pair of flattening rollers when the main scanning operation in the first direction is performed, and flattening the three-dimensional object being modeled by the other flattening roller of the pair of flattening rollers when the main scanning operation in the second direction is performed. According to this configuration, it is possible, for example, to accomplish the same effects as the configuration 1.

(Configuration 16) There is provided a method for modeling a three-dimensional object by a lamination modeling method. The method uses a head for coloring, which is an inkjet head configured to form an area of the three-dimensional object, which is to be colored with a predetermined color, by an ink for coloring; a head for modeling, which is an inkjet head configured to form at least an inner area of the three-dimensional object; and at least a pair of flattening rollers configured to flatten the three-dimensional object being modeled. The method includes enabling the head for coloring and the head for modeling to perform a main scanning operation of ejecting ink droplets while moving in a preset main scanning direction. One flattening roller of the pair of flattening rollers is arranged at one side in the main scanning direction with respect to the head for coloring and the head for modeling, and the other flattening roller of the pair of flattening rollers is arranged at the other side in the main scanning direction with respect to the head for coloring and the head for modeling. When controlling the main scanning operation, the method includes enabling at least the head for modeling to perform the main scanning operation in a first direction, which is one side direction of the main scanning direction, and at least the head for coloring to perform the main scanning operation in a second direction, which is the other side direction of the main scanning direction. The method includes flattening the three-dimensional object being modeled by the flattening roller positioned at the rear with respect to the head for coloring and the head for modeling during each of the main scanning operation in the first direction and the main scanning operation in the second direction. According to this configuration, it is possible, for example, to accomplish the same effects as the configuration 12.

(Configuration 17) There is provided a method for modeling a three-dimensional object by a lamination modeling method. The method uses a head for coloring, which is an inkjet head configured to form an area of the three-dimensional object, which is to be colored with a predetermined color, by an ink for coloring, and a head for modeling, which is an inkjet head configured to form at least an inner area of the three-dimensional object. The method includes forming a layer including a coloring layer, which is an ink layer to be formed by the head for coloring, and a modeling layer, which is an ink layer to be formed by the head for modeling, as each layer to be formed by the lamination modeling method. Upon the formation of each layer, the method includes performing a first layer forming operation of forming one layer of the coloring layer and the modeling layer by using one of the head for coloring and the head for modeling, and a second layer forming operation of forming the other layer of the coloring layer and the modeling layer to be adjacent to a wall part of the one layer by using the other of the head for coloring and the head for modeling after curing the one layer. According to this configuration, it is possible, for example, to accomplish the same effects as the configuration 13.

(Configuration 18) There is provided a method for modeling a three-dimensional object by a lamination modeling method. The method uses a head for coloring, which is an inkjet head configured to form an area of the three-dimensional object, which is to be colored with a predetermined color, by an ink for coloring; a head for modeling, which is an inkjet head configured to form at least an inner area of the three-dimensional object, and a head for support layer, which is an inkjet head configured to form a support layer configured to support a periphery of a three-dimensional object being modeled. The method includes forming a layer including a coloring layer, which is an ink layer to be formed by the head for coloring, a modeling layer, which is an ink layer to be formed by the head for modeling, and the support layer, which is an ink layer to be formed by the head for support layer, as each layer to be formed by the lamination modeling method. Upon the formation of each layer, the method includes performing a first layer forming operation of forming the modeling layer and the support layer by using the head for modeling and the head for support layer, and a second layer forming operation of forming the coloring layer by using the head for coloring after the first layer forming operation. During the first layer forming operation, the method includes forming the modeling layer and the support layer so as to sandwich an area, in which the coloring layer is later to be formed, between the modeling layer and the support layer, so that a wall part of the modeling layer is formed at one side of the area in which the coloring layer is to be formed and a wall part of the support layer is formed at the other side of the area in which the coloring layer is to be formed. During the second layer forming operation, the method includes forming the coloring layer between the wall part of the modeling layer and the wall part of the support layer. According to this configuration, it is possible, for example, to accomplish the same effects as the configuration 14.

According to the present disclosure, it is possible to appropriately model the three-dimensional object with high precision, for example.

### BRIEF DESCRIPTION OF THE DRAWINGS

FIGS. 1A and 1B illustrate an example of an apparatus for modeling a three-dimensional object according to an illustrative embodiment of the present disclosure, in which FIG. 1A illustrates an example of a configuration of main parts of the apparatus for modeling a three-dimensional object, and FIG. 1B illustrates an example of a three-dimensional object that is to be modeled by the apparatus for modeling a three-dimensional object.

FIG. 2 is a bottom view illustrating in detail an example of a configuration of an ejection unit.

FIGS. 3A and 3B are pictorial views illustrating an example of a configuration of the three-dimensional object that is to be modeled when modeling the colored three-dimensional object, in which FIG. 3A illustrates an example of a vertical section of the three-dimensional object and FIG. 3B illustrates an example of a horizontal section of the three-dimensional object.

FIGS. 4A and 4B illustrate in detail a main scanning operation that is to be performed in the illustrative embodiment, in which FIG. 4A illustrates an example of a pattern of the main scanning operation in a forward direction, and FIG. 4B illustrates an example of a pattern of the main scanning operation in a backward direction.

FIGS. 5A and 5B illustrate simplified ink layers, which are to be formed in a usual mode of the illustrative embodiment, in which FIG. 5A is a pictorial view illustrating a pattern of ink layers, which are to be formed during the main scanning operation in the forward direction, and FIG. 5B is a pictorial view illustrating a pattern of ink layers, which are to be formed during the main scanning operation in the backward direction.

### DETAILED DESCRIPTION OF THE DISCLOSURE

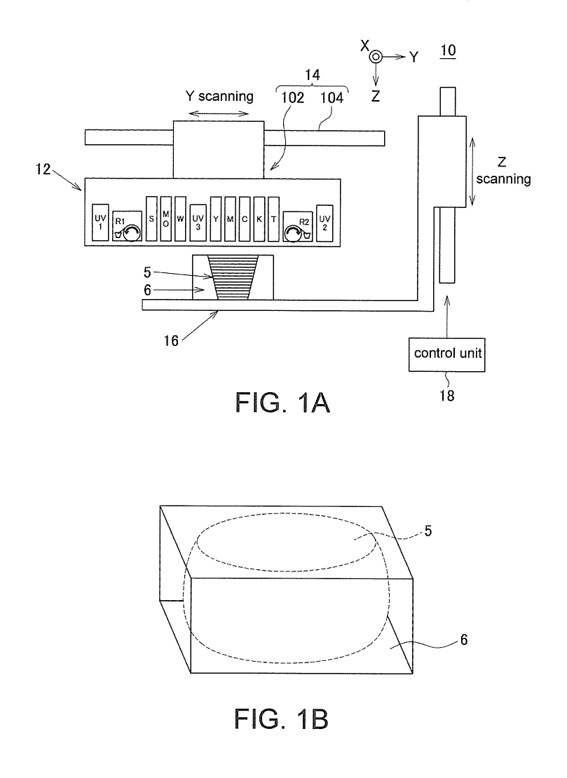

Hereinafter, an illustrative embodiment of the present disclosure will be described with reference to the drawings. FIGS. 1A and 1B illustrate an example of an apparatus 10 for modeling a three-dimensional object according to an illustrative embodiment of the present disclosure. FIG. 1A illustrates an example of a configuration of main parts of the apparatus 10 for modeling a three-dimensional object. FIG. 1B illustrates an example of a three-dimensional object 5 that is to be modeled by the apparatus 10 for modeling a three-dimensional object.

In this illustrative embodiment, the apparatus 10 for modeling a three-dimensional object is an apparatus for modeling a three-dimensional object 5 by a lamination modeling method. In this case, the lamination modeling method is a method of overlapping a plurality of layers to model a three-dimensional object 5. Also, the three-dimensional object 5 is a three-dimensional structure, for example. Also, in this illustrative embodiment, a method for modeling a three-dimensional object may be considered as a method for manufacturing a three-dimensional object.

Also, in this illustrative embodiment, the apparatus 10 for modeling a three-dimensional object is configured to model the three-dimensional object 5 of which at least a surface is colored, in accordance with data indicating the three-dimensional object 5 to be modeled, for example. In this case, the apparatus 10 for modeling a three-dimensional object is configured to model a colored three-dimensional structure by using shape information of the three-dimensional structure and color image information, for example. Also, the apparatus 10 for modeling a three-dimensional object may be configured to model a non-colored three-dimensional object, in accordance with a setting of an operation mode, for example. In this case, the apparatus 10 for modeling a three-dimensional object is configured to model a three-dimensional structure by using only the shape information of the three-dimensional structure of the shape information of the three-dimensional structure and the color image information, without using the color image information.

Also, the apparatus 10 for modeling a three-dimensional object may have the same or equivalent configuration as or to a well-known apparatus for modeling a three-dimensional object, except for a configuration that will be described later. Also, the apparatus 10 for modeling a three-dimensional object may be an apparatus implemented by changing a part of a configuration of a well-known inkjet printer. For example, the apparatus 10 for modeling a three-dimensional object may be an apparatus implemented by changing a part of an inkjet printer for printing a two-dimensional image, which uses ultraviolet curable ink (UV ink).

In this illustrative embodiment, the apparatus 10 for modeling a three-dimensional object has an ejection unit 12, a main scanning driving unit 14, a modeling platen 16 and a control unit 18. The ejection unit 12 is a part configured to eject droplets (ink droplets) becoming a material of the three-dimensional object 5, and is configured to eject ink droplets and the like of a curable resin, which is a resin to be cured depending on a predetermined condition, and to cure the same. Thereby, the ejection unit 12 is also configured to form each layer configuring the three-dimensional object 5. More specifically, in this illustrative embodiment, the ejection unit 12 has a plurality of inkjet heads and is configured to repeatedly execute several times an operation of ejecting the ink droplets to form a layer of the curable resin and an operation of curing the layer of the curable resin in accordance with an instruction of the control unit 18. Thereby, the ejection unit 12 overlaps and forms a plurality of cured layers of the curable resin.

Also, in this illustrative embodiment, an ultraviolet curable resin, which is cured by ultraviolet irradiation, is used as the curable resin. In this case, the ejection unit 12 is configured to eject the ink droplets of the ultraviolet curable ink, for example, as the ink droplets becoming the material of the three-dimensional object 5. Also, the ultraviolet is irradiated by an ultraviolet light source, for example, so that the layer of the curable resin is cured. In this case, the layer of the curable resin is a layer of the ultraviolet curable ink.

Also, in this illustrative embodiment, the ejection unit 12 is configured to form a support 6 around the three-dimensional object 5 upon the modeling of the three-dimensional object 5, as shown in FIG. 1B. The support 6 is a laminated structure configured to support the three-dimensional object 5 by surrounding a periphery of the three-dimensional object 5 being modeled. The support 6 is dissolved and removed by water, for example, after the modeling of the three-dimensional object 5 is completed.

Meanwhile, in this illustrative embodiment, the ink is liquid that is to be ejected from the inkjet heads, for example. Also, the inkjet head is a liquid ejection head configured to eject the liquid by an inkjet method. The inkjet method is a method of driving a driving element such as a piezo element to eject the ink droplets from nozzles, for example. In the meantime, the more specific configuration and operation of the ejection unit 12 will be described in more detail later.

The main scanning driving unit 14 is a driving unit for enabling the ejection unit 12 to perform the main scanning operation. In this case, the configuration of enabling the ejection unit 12 to perform the main scanning operation is to enable the inkjet heads of the ejection unit 12 to perform the main scanning operation, for example. Also, the main scanning operation is an operation of ejecting the ink droplets while moving in a preset main scanning direction (Y direction in the drawings), for example.

In this illustrative embodiment, the main scanning driving unit 14 has a carriage 102 and a guide rail 104. The carriage 102 is a holding unit configured to hold the inkjet heads and the like of the ejection unit 12 with facing the modeling platen 16. In this case, the configuration of holding the inkjet heads with facing the modeling platen 16 is to hold the inkjet heads so that an ejection direction of the ink droplets faces towards the modeling platen 16. Also, during the main scanning operation, the carriage 102 is configured to move along the guide rail 104 with holding the respective inkjet heads. The guide rail 104 is a rail-shaped member configured to guide the movement of the carriage 102, and is configured to move the carriage 102 in response to an instruction of the control unit 18 during the main scanning operation.

Also, in this illustrative embodiment, the main scanning driving unit 14 is configured to enable the inkjet heads of the ejection unit 12 to perform the reciprocal main scanning operation in the main scanning direction. In this case, during each main scanning operation in both the forward direction and the backward direction, some of the inkjet heads of the ejection unit 12 may be selected to eject the ink droplets. The main scanning operation that is to be performed in this illustrative embodiment will be described in more detail later.

In the meantime, the movement of the ejection unit 12 during the main scanning operation may be a relative movement to the three-dimensional object 5. For this reason, in a modified embodiment of the configuration of the apparatus 10 for modeling a three-dimensional object, a position of the ejection unit 12 may be fixed and the modeling platen 16 may be moved to move the three-dimensional object 5, for example.

The modeling platen 16 is a mounting table configured to place the three-dimensional object 5 being modeled on an upper surface thereof. In this illustrative embodiment, the modeling platen 16 has a function of moving the upper surface in a vertical direction (Z direction in the drawings), and is configured to move the upper surface in conformity to progressing of the modeling of the three-dimensional object 5, in response to an instruction of the control unit 18. Thereby, it is also possible to appropriately adjust a distance (gap) between a surface to be modeled of the three-dimensional object 5 being modeled and the ejection unit 12. In this case, the surface to be modeled of the three-dimensional object 5 is a surface on which a next layer is to be formed by the ejection unit 12, for example. Also, the scanning operation in the Z direction of vertically moving the modeling platen 16 relative to the ejection unit 12 may be performed by moving the ejection unit 12, for example.

The control unit 18 is a CPU of the apparatus 10 for modeling a three-dimensional object, for example, and is configured to control the respective units of the apparatus 10 for modeling a three-dimensional object on the basis of the shape information of the three-dimensional object 5 to be modeled, the color image information and the like, thereby controlling operations for modeling the three-dimensional object 5. According to this illustrative embodiment, it is possible to appropriately model the three-dimensional object 5.

In the meantime, the apparatus 10 for modeling a three-dimensional object may further have a variety of configurations necessary for the modeling, the coloring and the like of the three-dimensional object 5, for example, in addition to the configuration shown in FIG. 1A. For instance, the apparatus 10 for modeling a three-dimensional object may further have a sub-scanning driving unit for enabling the ejection unit 12 to perform a sub-scanning operation. In this case, the sub-scanning operation is an operation of moving the inkjet heads of the ejection unit 12 relative to the three-dimensional object 5 being modeled, in a sub-scanning direction (X direction in the drawings) orthogonal to the main scanning direction. For example, the sub-scanning driving unit enables the ejection unit 12 to perform the sub-scanning operation, as required, when modeling the three-dimensional object 5 of which a length in the sub-scanning direction is longer than a modeling width of the inkjet heads of the ejection unit 12. More specifically, the sub-scanning driving unit may be a driving unit configured to move the modeling platen 16 in the sub-scanning direction, for example. Also, the sub-scanning driving unit may be a driving unit configured to move the guide rail 104 together with the carriage 102 configured to hold the ejection unit 12, for example.

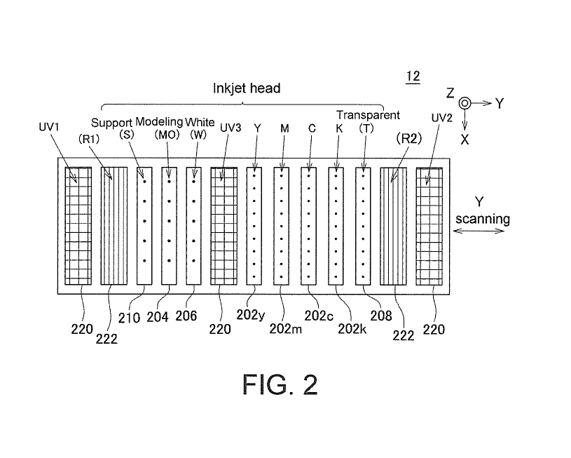

Subsequently, the more specific configuration and operation of the ejection unit 12 are described. FIG. 2 is a bottom view illustrating in detail an example of the configuration of the ejection unit 12. In this illustrative embodiment, the ejection unit 12 has a plurality of heads for coloring 202y, 202m, 202c, 202k (hereinafter, referred to as heads 202y to k for coloring), a head 206 for white ink, a head 208 for clear ink, a head 204 for modeling material, a head 210 for support layer, a plurality of ultraviolet light sources 220 and a plurality of flattening roller units 222. Also, the respective configurations of the ejection unit 12 are arranged at the carriage 102 (refer to FIG. 1A), which is the same support member. Also, in this illustrative embodiment, the ejection unit 12 has a pair of (two) flattening roller units 222, as the plurality of flattening roller units 222.

The heads 202y to k for coloring, the head 206 for white ink, the head 208 for clear ink, the head 204 for modeling material and the head 210 for support layer are examples of the ejection head configured to eject ink droplets of a curable resin by an inkjet method. Also, in this illustrative embodiment, the heads 202y to k for coloring, the head 206 for white ink, the head 208 for clear ink, the head 204 for modeling material and the head 210 for support layer are inkjet heads configured to eject ink droplets of ultraviolet curable ink, for example, and are disposed side by side in the main scanning direction (Y direction) with positions thereof being aligned in the sub-scanning direction (X direction).

The heads 202y to k for coloring are inkjet heads configured to form areas of the three-dimensional object 5, which are to be colored by preset colors, by coloring inks, and are configured to eject ink droplets of colored inks having different colors, respectively. In this illustrative embodiment, the heads 202y to k for coloring are configured to eject ink droplets of ultraviolet curable inks of respective colors of Y (yellow), M (magenta), C (cyan) and K (black).

Meanwhile, in this illustrative embodiment, the heads 202y to k for coloring are examples of the inkjet heads for respective process colors. Also, the respective colors of YMCK are examples of respective process colors. The ejection unit 12 may further have an inkjet head for a color such as flame color of each color, red (R), green (G), blue (B), orange and the like, as the head for coloring.

The head 206 for white ink is an inkjet head configured to eject ink droplets of white (W) ultraviolet curable ink. Also, the head 208 for clear ink is an inkjet head configured to eject ink droplets of ultraviolet curable clear ink. In this case, the clear ink is ink having a clear color, which is a transparent (T) color. The clear ink may be ink that includes an ultraviolet curable ink but does not include colorant. Also, the clear ink may be colorless and transparent ink.

The head 204 for modeling material is an inkjet head configured to eject ink droplets of ultraviolet curable ink to be used for modeling an inside of the three-dimensional object 5. In this illustrative embodiment, the head 204 for modeling material is configured to eject ink droplets of modeling ink MO of a predetermined color, thereby forming a modeling layer, which is an ink layer configuring an inside of the three-dimensional object 5. The modeling ink may be dedicated ink for modeling, for example. As the modeling ink, the white ink, the clear ink or the like may also be used, for example.

The head 210 for support layer is an inkjet head configured to form a support layer, which is an ink layer configuring the support 6 (refer to FIGS. 1A and 1B), and is configured to eject ink droplets including a material S of the support 6. As the material of the support 6, a well-known material for support may be suitably used, for example. In this illustrative embodiment, as the material of the support 6, a water-soluble material, which is capable of being dissolved by water after the modeling of the three-dimensional object 5, may be used. Also, since the material of the support 6 is removed after the modeling, a material of which a cure degree by the ultraviolet is lower than the modeled object and which is likely to be dissolved is preferably used as the material of the support 6. In this way, it is possible to perform the modeling using the support 6 more appropriately.

In the meantime, the well-known inkjet heads, for example, can be appropriately used as the heads 202y to k for coloring, the head 206 for white ink, the head 208 for clear ink, the head 204 for modeling material and the head 210 for support layer. Also, each of the inkjet heads has a nozzle line of which a plurality of nozzles is aligned side by side in the sub-scanning direction, on a surface facing the modeling platen 16 (refer to FIG. 1A). In this case, the nozzle lines of the respective inkjet heads are the same as regards the aligning direction and are parallel with each other. Also, during the main scanning operation, the inkjet heads eject the ink droplets in the Z direction while moving in the main scanning direction orthogonal to the aligning direction of the nozzles.

The plurality of ultraviolet light sources 220 is ultraviolet light sources configured to cure the ultraviolet curable ink. As the ultraviolet light sources 220, ultraviolet LEDs are preferably used, for example. Also, as the ultraviolet light sources 220, metal halide lamps, mercury lamps and the like may be used.

Also, in this illustrative embodiment, the ejection unit 12 has three ultraviolet light sources 220 denoted with reference numerals UV1 to UV3 in the drawings (hereinafter, referred to as light sources UV1 to UV3), as the plurality of ultraviolet light sources 220. Among them, the light sources UV1, UV2 are respectively positioned at one end-side and at the other end-side of the ejection unit 12 in the main scanning direction so that the respective inkjet heads of the ejection unit 12 are positioned therebetween. More specifically, for example, the light source UV1 is arranged at the one end-side of the ejection unit 12. Also, the light source UV2 is arranged at the other end-side of the ejection unit 12.

Also, the light source UV3 is arranged in the arrangement of the plurality of inkjet heads of the ejection unit 12. More specifically, in this illustrative embodiment, as shown, the light source UV3 is arranged in the arrangement of the plurality of inkjet heads so that the heads 202y to k for coloring and the head 208 for clear ink, which are the inkjet heads to be used to form a coloring area, are positioned between the light source UV3 and the light source UV2 and the other inkjet heads are positioned between the light source UV3 and the light source UV1.

The plurality of flattening roller units 222 is configured to flatten a layer of ultraviolet curable ink, which is formed during the modeling of the three-dimensional object 5. In this illustrative embodiment, the ejection unit 12 has the pair of (two) flattening roller units 222. Also, the flattening roller units 222 are respectively arranged at one end-side and at the other end-side in the main scanning direction with respect to the arrangement of the inkjet heads of the ejection unit 12. Thereby, the pair of flattening roller units 222 is arranged side by side in the main scanning direction with respect to the arrangement of the inkjet heads of the ejection unit 12 with positions thereof being aligned in the sub-scanning direction.

More specifically, in this illustrative embodiment, the flattening roller unit 222 denoted with a reference numeral R1 of the pair of flattening roller units 222 is arranged between the arrangement of the inkjet heads and the light source UV1. Also, the flattening roller unit 222 denoted with a reference numeral R2 is arranged between the arrangement of the inkjet heads and the light source UV2.

By the above configuration, the ejection unit 12 is configured to perform an operation of modeling the three-dimensional object 5, in response to an instruction of the control unit 18 (refer to FIG. 1A). Also, when performing the modeling operation, the ink layer is flattened by the pair of flattening roller units 222. The flattening operation will be described in more detail later.

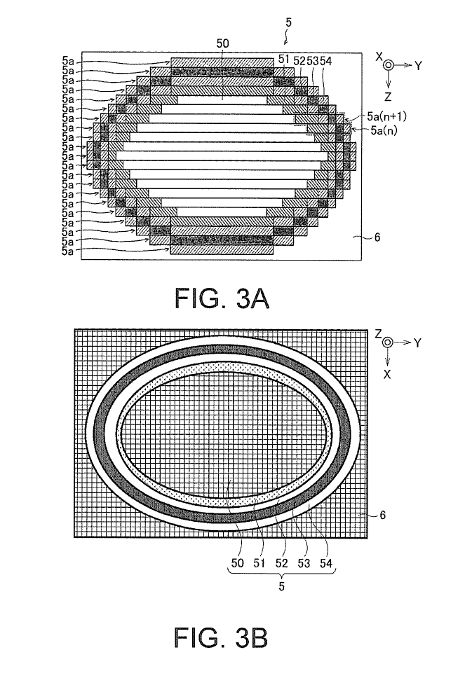

Subsequently, the more specific configuration of the three-dimensional object 5, which is to be modeled in the illustrative embodiment, is described. FIGS. 3A and 3B are pictorial views illustrating an example of the configuration of the three-dimensional object 5 that is to be modeled when modeling the colored three-dimensional object 5 in this illustrative embodiment. FIG. 3A illustrates an example of a vertical section of the three-dimensional object 5. FIG. 3B illustrates an example of a horizontal section of the three-dimensional object 5.

As described above, in this illustrative embodiment, the apparatus 10 for modeling a three-dimensional object is configured to overlap a plurality of layers of the ultraviolet curable ink, thereby modeling the three-dimensional object 5. More specifically, the apparatus is configured to overlap a plurality of layers denoted with a reference numeral 5a in FIG. 3A, thereby modeling the three-dimensional object 5, for example. For example, the layers denoted with reference numerals 5a(n) and 5a(n+1) in FIG. 3A indicate a n^{th} layer and a (n+1)^{th} layer from below, for example. Also, as described above with reference to FIG. 1B and the like, the apparatus 10 for modeling a three-dimensional object is configured to form the support 6 around the three-dimensional object 5 by using the head 210 for support layer.

Also, in this illustrative embodiment, the apparatus 10 for modeling a three-dimensional object is configured to form an ink layer configuring respective areas of an inner modeling area 50, an inner white area 51, an inner clear area 52, a coloring area 53 and an outer clear area 54, as a layer of the ultraviolet curable ink configuring each layer to be formed by the lamination modeling method. Among the areas, the inner modeling area 50 and the inner white area 51 are areas for modeling configuring an inside of the three-dimensional object 5. Also, the inner clear area 52, the coloring area 53 and the outer clear area 54 are an outlying area surrounding an inner area. Also, at least the coloring area 53 is an area of which a color is capable of being visibly recognized from an outside of the three-dimensional object 5.

The inner modeling area 50 is an area configuring the innermost part of the three-dimensional object 5. In this case, the innermost part of the three-dimensional object 5 is a part surrounded by the other areas (the inner white area 51, the inner clear area 52, the coloring area 53 and the outer clear area 54) in each layer that is to be formed by the lamination modeling method, for example. In this illustrative embodiment, the inner modeling area 50 is formed using the head 204 for modeling material. In the meantime, the inner modeling area 50 is an area configuring a basic part of a shape of the three-dimensional object 5. The inner modeling area 50 may be an area of which a part is void.

The inner white area 51 is a white layer area configured to surround the periphery of the inner modeling area 50 in contact with the inner modeling area 50. Also, the inner white area 51 contacts the coloring area 53 with the inner clear area 52 being interposed therebetween in an outer direction of the three-dimensional object 5. By this configuration, the inner white area 51 is configured to reflect light, which is incident from an outside of the three-dimensional object 5 through the coloring area 53. By this configuration, it is possible to implement a color expression by a subtractive color process for a color colored in the coloring area 53, for example. Also, by this configuration, it is possible to make a color colored in the coloring area 53 be visibly recognized as a more appropriate color from the outside of the three-dimensional object 5.

In this illustrative embodiment, the inner white area 51 is formed using the head 206 for white ink, for example. Also, the color of the inner white area 51 may be white or a color close to white within a range in which the color expression by the subtractive color process can be implemented.

The inner clear area 52 is an area configured to surround the inner modeling area 50 with the inner white area 51 being interposed therebetween, and is configured to contact both the inner white area 51 and the coloring area 53 between the inner white area 51 positioned at an inner side and the coloring area 53 positioned at an outer side. Also, in this illustrative embodiment, the inner clear area 52 is formed using the head 208 for clear ink. The inner clear area 52 is formed, so that it is possible to appropriately prevent the white ink of the inner white area 51 and the YMCK inks of the coloring area 53 from being mixed even though the inner white area 51 and the coloring area 53 are formed at the same time and are flattened when using an operation mode of performing the modeling at high speed, for example. For this reason, by this configuration, it is possible to perform the flattening operation of the flattening roller units 222 more appropriately, for example.

The coloring area 53 is an area configured to surround the inner modeling area 50 with the inner white area 51 and the inner clear area 52 being interposed therebetween. Also, in this illustrative embodiment, the coloring area 53 is an area of which a color is capable of being visibly recognized from the outside of the three-dimensional object 5 through the outer clear area 54. The apparatus 10 for modeling a three-dimensional object is configured to enable the heads 202y to k for coloring to eject the ink droplets on the basis of an image indicating the color image information, thereby coloring the coloring area 53. Also, in this illustrative embodiment, the head 208 for clear ink is further used to form the coloring area 53, in addition to the heads 202y to k for coloring. Thereby, the apparatus 10 for modeling a three-dimensional object forms the coloring area 53 by the YMCK inks and the clear ink.

Here, when coloring the coloring area 53, the ink droplets of respective YMCK colors, which are color inks, are ejected to respective positions of the coloring area 53 in a ratio of colors to be colored at each position. In this case, each position of the coloring area 53 is an area including a plurality of adjacent spotting positions (droplet attaching positions). Also, the spotting position is a spotting position of the ink droplet to be ejected during the main scanning operation, for example. In this case, for example, when the coloring area 53 is formed only by the color inks, there are concerns that an ink amount per volume may be different due to the colors of the respective positions.

Regarding this, according to the illustrative embodiment, as described above, the coloring area 53 is forming using not only the color inks but also the clear ink. In this case, the head 208 for clear ink is configured to eject the ink droplets of the clear ink to the coloring area 53 so that the ink amount per volume is supplemented at each position of the coloring area 53. By this configuration, it is possible to make a total volume of the color inks and the clear ink substantially constant at each position of the coloring area 53, for example. Also, by this configuration, it is possible to model and color the three-dimensional object 5 with higher precision, for example. For this reason, according to this illustrative embodiment, it is possible to color the three-dimensional object 5 more appropriately when modeling the colored three-dimensional object 5, for example.

In the meantime, it is also considered to color only a part of the area, depending on the using applications of the three-dimensional object 5. In this case, the coloring area 53 may be formed only by the clear ink for an area for which the coloring is not performed. Also, the coloring area 53 may be omitted for the part of the area.

The outer clear area 54 is an area configured to surround the inner modeling area 50 with the inner white area 51, the inner clear area 52 and the coloring area 53 being interposed therebetween, and configures the outermost surface of the three-dimensional object 5. In this illustrative embodiment, the outer clear area 54 is formed using the head 208 for clear ink. The outer clear area 54 is formed, so that it is possible to appropriately protect the surface of the three-dimensional object 5. Also, for example, it is possible to prevent the coloring area 53 from being discolored due to the ultraviolet of the natural light. Like this, according to the illustrative embodiment, it is possible to appropriately model and color the three-dimensional object 5, for example.

Here, as described above, the apparatus 10 for modeling a three-dimensional object is configured to form the inner modeling area 50 and inner white area 51 by using the head 204 for modeling material and the head 206 for white ink, as an inner area of the three-dimensional object 5. For this reason, in this illustrative embodiment, it can be said that the head 204 for modeling material and the head 206 for white ink are used as a head for modeling. In this case, the head for modeling is an inkjet head configured to form at least an inner area of the three-dimensional object 5, for example.

Also, although not shown, when modeling the three-dimensional object 5 without performing the coloring, the apparatus 10 for modeling a three-dimensional object models the three-dimensional object 5 consisting of only the area for modeling, for example. In this case, an inside area and an outlying area of the three-dimensional object 5 may be the same area as the inner modeling area 50 when performing the coloring. Also, for example, an area that is to be formed of the white ink or clear ink may be formed as the outlying area, as required.

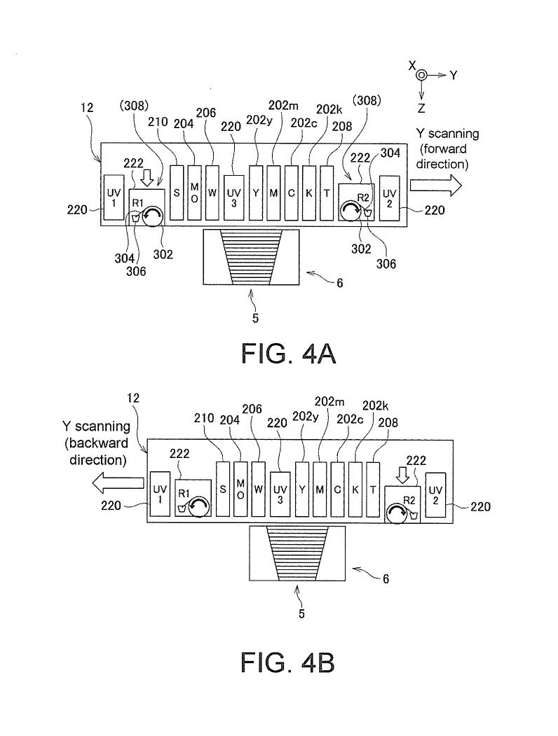

Subsequently, the operation of forming the respective layers configuring the three-dimensional object 5 and the flattening operation according to this illustrative embodiment are described in more detail. FIGS. 4A and 4B illustrate in detail the main scanning operation that is performed in this illustrative embodiment. FIG. 4A illustrates an example of a pattern of the main scanning operation in a forward direction. FIG. 4B illustrates an example of a pattern of the main scanning operation in a backward direction.

As described above, in this illustrative embodiment, the main scanning driving unit 14 (refer to FIG. 1A) is configured to enable the inkjet heads of the ejection unit 12 to perform the reciprocal main scanning operation in the main scanning direction. In this case, one of the forward direction and the backward direction of the reciprocation is an example of a first direction, which is one side direction of the main scanning direction. Also, the other of the forward direction and the backward direction is an example of a second direction, which is the other side direction of the main scanning direction. Also, in this illustrative embodiment, during each main scanning operation in the forward direction and the backward direction, the three-dimensional object 5 being modeled is flattened by the flattening roller unit 222 of the pair of flattening roller units 222, which is positioned at the rear of the inkjet heads with respect to the moving direction upon the main scanning operation.

Here, in this illustrative embodiment, each flattening roller unit 222 has a roller 302, a doctor blade 304, an ink collection unit 306 and a roller advance/retreat driving unit 308. The roller 302 is a flattening roller configured to operate as a flattening mechanism configured to flatten an ink layer, and is configured to flatten the ink layer, thereby adjusting a thickness of the ink layer to be deposited of the three-dimensional object 5. The roller 302 may be a smoothing roller configured to smooth a surface of an ink layer. Also, the roller 302 is preferably a roller having wettability as regards the ultraviolet curable ink, which is used in the ejection unit 12.

Also, in this illustrative embodiment, the roller 302 of the one flattening roller unit 222 of the pair of flattening roller units 222 and the roller 302 of the other flattening roller unit 222 are configured to rotate in different directions when performing the flattening. By this configuration, it is possible to appropriately rotate the rollers 302 of the respective flattening roller units 222, depending on the direction of the main scanning operation of performing the flattening.

In the meantime, the description ‘flattening the three-dimensional object being modeled’ means flattening the uppermost ink layer of the ink layers sequentially formed by the lamination modeling method. Also, the roller 302 is configured to scrape a part of the ink layer, thereby flattening the ink layer. The roller 302 may have a function of a smoothing roller configured to smooth an ink layer.

The doctor blade 304 has a configuration for removing the ink scraped by the roller 302 from a surface of the roller 302. The ink collection unit 306 has a configuration for collecting the ink removed from the surface of the roller 302 by the doctor blade 304.

The roller advance/retreat driving unit 308 is a driving unit configured to advance and retreat the roller 302 in a direction facing towards the three-dimensional object 5 from the ejection unit 12, and is configured to advance and retreat each of the rollers 302 of the pair of flattening roller units 222 in a direction (Z direction) facing towards the three-dimensional object 5 from the ejection unit 12. In this case, the direction facing towards the three-dimensional object 5 from the ejection unit 12 is a thickness direction of an ink layer to be deposited by the lamination modeling method, for example. More specifically, in this illustrative embodiment, when enabling the flattening roller unit 222 to perform the flattening, the roller advance/retreat driving unit 308 advances the roller 302 of the flattening roller unit 222 to bring the flattening roller 302 close to the three-dimensional object 5 being modeled. Thereby, the roller advance/retreat driving unit 308 arranges the roller 302 at a position at which the flattening is performed.

Also, when not enabling the flattening roller unit 222 to perform the flattening, the roller advance/retreat driving unit 308 retreats the roller 302 of the flattening roller unit 222 to separate the flattening roller 302 from the three-dimensional object being modeled. Thereby, the roller advance/retreat driving unit 308 retreats the roller 302 to the position at which the flattening is performed.

More specifically, in this illustrative embodiment, during the main scanning operation in the forward direction, the roller advance/retreat driving unit 308 arranges the roller 302 of the flattening roller unit 222 denoted with the reference numeral R1 of the pair of flattening roller units 222 at the advanced position and arranges the roller 302 of the flattening roller unit 222 denoted with the reference numeral R2 at the retreated position, as shown in FIG. 4A. Thereby, the roller 302 of the flattening roller unit 222 denoted with the reference numeral R1 is enabled to perform the flattening.

Also, during the main scanning operation in the backward direction, the roller advance/retreat driving unit 308 arranges the roller 302 of the flattening roller unit 222 denoted with the reference numeral R2 of the pair of flattening roller units 222 at the advanced position and arranges the roller 302 of the flattening roller unit 222 denoted with the reference numeral R1 at the retreated position, as shown in FIG. 4B. Thereby, the roller 302 of the flattening roller unit 222 denoted with the reference numeral R2 is enabled to perform the flattening.

Meanwhile, in this illustrative embodiment, the roller advance/retreat driving unit 308 is configured as a function of a part of each of the pair of flattening roller units 222. Also, for convenience of illustrations, in FIGS. 4A and 4B, a specific configuration of the roller advance/retreat driving unit 308 is not shown and only a reference numeral is shown. In a modified embodiment of the configuration of the ejection unit 12, the roller advance/retreat driving unit may be arranged separately from the pair of flattening roller units 222. In this case, the roller advance/retreat driving unit is configured to move each flattening roller unit 222 in the Z direction, thereby advancing and retreating the roller 302 of each flattening roller unit 222.

Subsequently, the main scanning operation of the illustrative embodiment including operations, in addition to the flattening operation, is described in more detail. By the above configuration, in this illustrative embodiment, as shown in FIG. 4A, the ejection unit 12 is moved in a predetermined direction (for example, a rightward direction in FIG. 4A) to perform the main scanning operation in the forward direction. Thereby, for example, the ink droplets are ejected from the respective inkjet heads of the ejection unit 12. In this case, the ink droplets may be ejected from only some inkjet heads of the ejection unit 12.

As described above, during the main scanning operation in the forward direction, the flattening is performed by the roller 302 of the flattening roller unit 222 denoted with the reference numeral R1. In this case, the flattening roller unit 222 denoted with the reference numeral R1 is the flattening roller unit 222 of the pair of flattening roller units 222, which is positioned at the rear with respect to the moving direction during the main scanning operation. Also, the light source UV1, which is the ultraviolet light source 220 arranged at the rear of the corresponding flattening roller unit 222, is turned on, so that the ink layer Rallied at the uppermost part of the three-dimensional object 5 is cured. Thereby, during the one main scanning operation, the ink layer curing operation is performed at the same time as the ink layer forming operation.

More specifically, in this illustrative embodiment, when the apparatus 10 for modeling a three-dimensional object performs an operation in a standard operation mode (hereinafter, referred to as usual mode), the ink droplets are ejected from the head 204 for modeling material, the head 206 for white ink and the head 210 for support layer of the inkjet heads of the ejection unit 12 on the basis of data (modeling data) indicating the three-dimensional object 5 being modeled during the main scanning operation in the forward direction. Thereby, during the operation in the usual mode, the ink layers configuring the inner modeling area 50 and inner white area 51 of the three-dimensional object 5 and the ink layer configuring the support 6 are formed during the main scanning operation in the forward direction. In this case, the ink layers configuring the inner modeling area 50 and inner white area 51 are examples of the modeling layer.

Also, in this case, as described above, the flattening roller unit 222 denoted with the reference numeral R1 is moving downwards with respect to the Z-axis direction by the operation of the roller advance/retreat driving unit 308. Thereby, the roller 302 of the flattening roller unit 222 is contacted to an upper surface of the three-dimensional object 5 being modeled and flattens the same. Also, the light source UV1 cures the ink layer formed at the uppermost part of the three-dimensional object 5 being modeled.

Also, in this case, the light source UV3 is also preferably turned on during the main scanning operation in the forward direction, in addition to the light source UV1. By this configuration, for example, before a new ink layer is formed, it is possible to appropriately compensate for an insufficiently cured part of the ink layer already formed. Also, in this case, for example, the ink layer may be preliminarily cured (semi-cured) by the light source UV1 during each main scanning operation and then the ink layer may be fully cured by the light source UV3 during the separate main scanning operation. In this case, the preliminary curing indicates a state where the viscosity of the ink layer is increased without completely curing ink dots. The full curing indicates a state where the curing is completed within a range of necessary precision.

In this way, in this illustrative embodiment, during the main scanning operation in the forward direction, the ink layers configuring the inner modeling area 50, the inner white area 51 and the support 6 are formed by the head 204 for modeling material, the head 206 for white ink and the head 210 for support layer. Also, in this case, as seen from the outside of the three-dimensional object 5, for example, a support layer formed by the head 210 for support layer, a white ink layer formed by the head 206 for white ink and a modeling layer formed by the head 204 for modeling material are sequentially formed in corresponding order. As a result, the parts corresponding to the inner clear area 52, the coloring area 53 and the outer clear area 54, i.e., the areas in which a coloring ink layer and a clear ink layer should be thereafter formed by the heads 202y to k for coloring and the head 208 for clear ink are omitted. Thereby, the areas in which ink layers should be thereafter formed by the heads 202y to k for coloring and the head 208 for clear ink become areas having a recess shape positioned between wall parts of the ink layers already formed.

Also, after the main scanning operation in the forward direction is completed, the roller advance/retreat driving unit 308 of the flattening roller unit 222 denoted with the reference numeral R1 moves the roller 302 upwards with respect to the Z-axis direction. Thereby, the roller 302 is retreated to a position at which it is not contacted to the upper surface of the three-dimensional object 5 being modeled. Also, the roller advance/retreat driving unit 308 of the flattening roller unit 222 denoted with the reference numeral R2 moves the roller 302 downwards with respect to the Z-axis direction.

Also, subsequently to the main scanning operation in the forward direction, the ejection unit 12 is moved in an opposite direction (for example, a leftward direction in FIG. 4B) to the forward direction, so that the main scanning operation in the backward direction is performed, as shown in FIG. 4B. Thereby, for example, the ink droplets are ejected from the respective inkjet heads of the ejection unit 12. Also in this case, the ink droplets may be ejected from only some inkjet heads of the ejection unit 12.

Also, during the main scanning operation in the backward direction, the flattening is performed by the roller 302 of the flattening roller unit 222 denoted with the reference numeral R2. In this case, the flattening roller unit 222 denoted with the reference numeral R2 is the flattening roller unit 222 of the pair of flattening roller units 222, which is positioned at the rear with respect to the moving direction during the main scanning operation. Also, the light source UV2, which is the ultraviolet light source 222 positioned at the rear of the corresponding flattening roller unit 222, is turned on, so that the ink layer formed at the uppermost part of the three-dimensional object 5 is cured.

More specifically, in this illustrative embodiment, when the apparatus 10 for modeling a three-dimensional object performs the operation in the usual mode, the ink droplets are ejected from the heads 202y to k for coloring and the head 208 for clear ink of the inkjet heads of the ejection unit 12 on the basis of data (coloring data) indicating a method of coloring the three-dimensional object 5, during the main scanning operation in the backward direction. Thereby, during the operation in the usual mode, the ink layers configuring the inner clear area 52, the coloring area 53 and the outer clear area 54 of the three-dimensional object 5 are formed during the main scanning operation in the backward direction. In this case, the ink layer configuring the coloring area 53 is an example of the coloring layer.

Also, in this case, as described above, the flattening roller unit 222 denoted with the reference numeral R2 is moving downwards with respect to the Z-axis direction by the operation of the roller advance/retreat driving unit 308. Thereby, the roller 302 of the flattening roller unit 222 is contacted to the upper surface of the three-dimensional object 5 being modeled and flattens the same. Also, the light source UV2 cures the ink layer formed at the uppermost part of the three-dimensional object 5 being modeled.

Also, in this case, the light source UV3 is also preferably turned on during the main scanning operation in the backward direction, in addition to the light source UV2. By this configuration, for example, before a new ink layer is formed, it is possible to appropriately compensate for an insufficiently cured part of the ink layer already formed. Also, in this case, for example, the ink layer may be preliminarily cured by the light source UV2 during each main scanning operation and then the ink layer may be fully cured by the light source UV3 during the separate main scanning operation.

In this way, in this illustrative embodiment, during the main scanning operation in the backward direction, the ink layers configuring the inner clear area 52, the coloring area 53 and the outer clear area 54 are formed by the heads 202y to k for coloring and the head 208 for clear ink. Also, in this case, the heads 202y to k for coloring and the head 208 for clear ink form the ink layers in the areas having a recess shape formed during the main scanning operation in the forward direction.

Also, following the above process, a position of the modeling platen 16 is lowered in the vertical direction (Z-axis direction) by a height corresponding to a thickness t of an ink layer to be formed next time. In this case, in this illustrative embodiment, the position of the modeling platen 16 is lowered, taking into consideration a thickness of the ink to be removed by the flattening of the flattening roller unit 222.

In the meantime, the ink thickness to be removed by the flattening is set in accordance with a non-uniformity of an ejection amount from each nozzle of the inkjet head, for example. Also, it is thought that the ejection amount from each nozzle of the inkjet head has a non-uniformity of about ±15%. In this case, for example, it is considered to scrape a thickness of about 30%, which is the non-uniformity, by the roller 302. More specifically, when the thickness (Z direction) of the ink layer before the flattening is non-uniform within a range of 18 μm to 22 μm due to the non-uniformity of the ejection amount from each nozzle of the inkjet head, the modeling platen 16 may be lowered by t (=18 μm).

After that, the above operations are repeated. According to this illustrative embodiment, it is possible to appropriately model the colored three-dimensional object 5. Also, in this case, during the main scanning operation in which the flattening is performed by the roller 302, the position of the lower end of the roller 302 in the vertical direction (Z direction) is constant each time. For this reason, the roller 302 each time flattens the ink layer by the size corresponding to the moving distance of the modeling platen 16 before the flattening.

Here, like the illustrative embodiment, when the reciprocal main scanning operation is performed and the flattening is performed during each main scanning operation in the forward direction and the backward direction, there may be a case where the flattening cannot be appropriately performed simply by using the plurality of flattening rollers. Regarding this, in this illustrative embodiment, the pair of flattening roller units 222 is used, and the roller 302 of each flattening roller unit 222 is also appropriately moved by the roller advance/retreat driving unit 308. Thereby, for example, during each main scanning operation, it may be possible to appropriately bring only the roller 302 of the one flattening roller unit 222 of the pair of flattening roller units 222, which is positioned at the rear with respect to the moving direction during the main scanning operation, into contact with the ink layer on the upper surface of the three-dimensional object 5 being modeled. For this reason, according to this illustrative embodiment, during each main scanning operation in the forward direction and the backward direction, it is possible to more appropriately perform the flattening with high precision with respect to the size in the lamination direction (Z direction). Thereby, for example, it is also possible to appropriately model the three-dimensional object with high precision without remarkably increasing the time necessary for the modeling.

Also, as described above, according to the operation in the usual mode of the illustrative embodiment, during the main scanning operation in the forward direction, the ink layers configuring the inner modeling area 50, the inner white area 51 and the support 6 are first formed by the head 204 for modeling material, the head 206 for white ink and the head 210 for support layer and then during the main scanning operation in the backward direction, the ink layers configuring the inner clear area 52, the coloring area 53 and the outer clear area 54 are formed by the heads 202y to k for coloring and the head 208 for clear ink. In the below, the corresponding features are described in more detail.

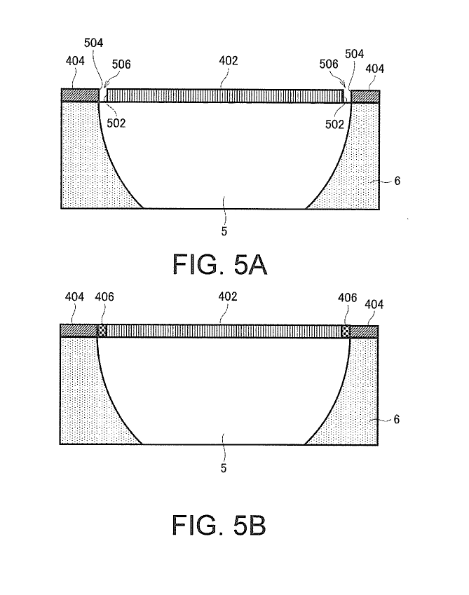

FIGS. 5A and 5B illustrate simplified ink layers, which are to be formed in the usual mode of the illustrative embodiment. FIG. 5A is a pictorial view illustrating a pattern of the ink layers, which are to be formed by the main scanning operation in the forward direction.

As described above, according to the operation in the usual mode of the illustrative embodiment, during the main scanning operation in the forward direction, the ink layers configuring the inner modeling area 50, the inner white area 51 and the support 6 are first formed by the head 204 for modeling material, the head 206 for white ink and the head 210 for support layer. Thereby, a modeling layer 402 is formed at the uppermost part of the three-dimensional object 5 being modeled, and a support layer 404 is formed at the uppermost part of the support 6 surrounding the three-dimensional object 5. Also, the formed layers are flattened by the roller 302 of the flattening roller unit 222 denoted with the reference numeral R1 in FIGS. 4A and 4B.

Here, in the configuration shown in FIG. 5A, the modeling layer 402 is a combined part of the model layer formed by the head 204 for modeling material and the white ink layer formed by the head 206 for white ink. Also, the head 204 for modeling material and the head 206 for white ink are examples of a head for modeling configured to form a modeling layer. In this case, the main scanning operation in the forward direction can be said as an operation of enabling only the head for modeling of the head for modeling and the head for coloring to eject the ink droplets and flattening the ink layer, which is formed by the head for modeling, by the roller 302 of the one flattening roller unit 222. Also, in this illustrative embodiment, the main scanning operation in the forward direction is an example of a first layer forming operation of forming a modeling layer and a support layer by using the head for modeling and the head for support layer.

Also, in this illustrative embodiment, during the main scanning operation in the forward direction, the ink layers are formed in the parts except for areas 506 in which the ink layers are later to be formed by the heads 202y to k for coloring and the head 208 for clear ink. More specifically, during the main scanning operation in the forward direction, the modeling layer 402 and the support layer 404 are formed so that the areas 506 are respectively sandwiched between the modeling layer 402 and the support layer 404. Thereby, a wall part 502 of the modeling layer 402 is formed at one side of the area 506 and a wall part 504 of the support layer 404 is formed at the other side of the area 506. For this reason, the area 506 becomes an area having a recess shape positioned between the wall part 502 and the wall part 504 at a point in time at which the main scanning operation in the forward direction is completed. Also, during the main scanning operation in the backward direction, ink layers are formed in the areas 506 having the recess shape.

FIG. 5B is a pictorial view illustrating a pattern of the ink layers, which are to be formed by the main scanning operation in the backward direction. As described above, according to the operation in the usual mode of the illustrative embodiment, during the main scanning operation in the backward direction, the ink layers configuring the inner clear area 52, the coloring area 53 and the outer clear area 54 are formed by the heads 202y to k for coloring and the head 208 for clear ink. Thereby, outlying ink layers 406, which are ink layers formed in the outlying area of the three-dimensional object 5, are formed on the areas 506 at the uppermost part of the three-dimensional object 5 being modeled. Also, the outlying ink layers 406 are flattened by the roller 302 of the flattening roller unit 222 denoted with the reference numeral R2 in FIGS. 4A and 4B.

Here, in the configuration shown in FIG. 5B, the outlying ink layer 406 is a combined part of the coloring layer formed by the heads 202y to k for coloring and the clear ink layer formed by the head 208 for clear ink. Also, the main scanning operation in the backward direction can be said as an operation of enabling only the head for coloring of the head for modeling and the head for coloring to eject the ink droplets and flattening the ink layer, which is formed by the head for coloring, by the roller 302 of the other flattening roller unit 222. Also, in this illustrative embodiment, the main scanning operation in the backward direction is an example of a second layer forming operation of forming a coloring layer by using the head for coloring after the first layer forming operation. Also, the second layer forming operation is an operation of forming a coloring layer in the area 506 between the wall part 502 of the modeling layer 402 and the wall part 504 of the support layer 404.

Here, in general, if the ink for modeling and the ink for coloring are mixed when modeling a colored three-dimensional object, a blurring occurs, for example, so that an outward appearance quality of the three-dimensional object may be deteriorated. Also, for example, when the flattening is performed by the flattening roller at a situation where the ink for modeling and the ink for coloring are at a liquid state, the blurring is likely to occur.

In contrast, according to this illustrative embodiment, as described above, the operation of modeling the three-dimensional object 5 by the head 204 for modeling material and the head 206 for white ink, which are the heads for modeling, and the operation of coloring the three-dimensional object 5 by the heads 202y to k for coloring are performed during each main scanning operation in the forward direction and the backward direction, so that the corresponding operations can be separately performed during each of the main scanning operations. For this reason, even when the flattening is performed during each main scanning operation, the flattening is not performed in a situation where the ink for modeling and the ink for coloring are at a liquid state. For this reason, according to this illustrative embodiment, it is possible to appropriately prevent the ink for modeling and the ink for coloring from being mixed due to the flattening operation.

More specifically, in this illustrative embodiment, the modeling layer and the support layer are formed during the main scanning operation in the forward direction at a state where the areas 506 in which the coloring layer and the like are later to be formed are empty, and then the coloring layer and the like are formed during the main scanning operation in the backward direction. For this reason, even when the flattening is performed by the roller 302, it is possible to appropriately prevent the inks from being mixed in the main scanning direction among the three types of layers, i.e., the modeling layer, the support layer and the coloring layer. Thereby, it is possible to appropriately perform the modeling in which the surface is finely colored.

Also, in this illustrative embodiment, as described above, during the main scanning operation in the forward direction, the wall part 502 of the modeling layer 402 and the wall part 504 of the support layer 404 are formed so that the areas 506 in which the coloring layer and the like are later to be formed are respectively positioned therebetween. As a result, the area 506 becomes an area having a recess shape. In this case, when forming the outlying ink layer 406 including the coloring layer during the main scanning operation in the backward direction, the wall parts 502, 504 of the recess function as a guide for defining a position at which the outlying ink layer 406 is to be forming. For this reason, according to this illustrative embodiment, for example, it is possible to appropriately prevent the position of the coloring layer from deviating and the coloring layer from being obliquely formed. Thereby, for example, it is possible to more appropriately form the colored three-dimensional object 5 with high precision.

As described above, according to this illustrative embodiment, it is possible to appropriately form the colored three-dimensional object with high precision by the operation in the usual mode. In the apparatus 10 for modeling a three-dimensional object, it is also considered to perform an operation in a mode other than the usual mode, depending on the required function and performance. In the below, the operation in the mode other than the usual mode is described.

As described above, in this illustrative embodiment, the operation in the usual mode is the operation of performing the modeling and the coloring by the separate main scanning operations. In this case, since the ink mixing is difficult to occur between the modeling layer and the coloring layer, it is possible to appropriately form a three-dimensional object of a high quality. However, in this case, since the ink layer of one layer is formed by the reciprocal main scanning operation, it takes double time, as compared to a configuration where the modeling layer and the coloring layer are formed by one main scanning operation, for example. In this case, the ink layer of one layer means one layer denoted with a reference numeral 5a in FIG. 3A, for example.

For this reason, it is also considered to perform an operation of a high-speed mode capable of performing the modeling at higher speed, depending on the quality required for a three-dimensional object to be modeled. In this case, for example, during each main scanning operation in the forward direction and the backward direction, the head 204 for modeling material and the head 206 for white ink, which are the heads for modeling, and the heads 202y to k for coloring are both enabled to eject the ink droplets. Also, in this case, during each main scanning operation, all the heads for ink including the head 208 for clear ink and the head 210 for support layer are preferably enabled to eject the ink droplets. By this configuration, for example, it is possible to appropriately shorten the time required to form the three-dimensional object 5.

Also, in this case, regarding the ultraviolet light sources 220, it is considered to turn on the light sources UV1, UV2 all the time without turning on the light source UV3, for example. By this configuration, it is possible to appropriately cure the ink layers formed during each main scanning operation, for example.

Also, the flattening operation is preferably performed in the same manner as the usual mode. More specifically, for example, during the main scanning operation in the forward direction, the flattening is performed by the roller 302 of the flattening roller unit 222 denoted with the reference numeral R1 in the same manner as the flattening operation described with reference to FIG. 4A. Also, for example, during the main scanning operation in the backward direction, the flattening is performed by the roller 302 of the flattening roller unit 222 denoted with the reference numeral R2 in the same manner as the flattening operation described with reference to FIG. 4B. By this configuration, it is possible to appropriately flatten the three-dimensional object during the operation of the high speed mode, too.

In this way, the operation of the high speed mode is performed, so that it is possible to appropriately form the ink layer of one layer in the lamination modeling method and to flatten the ink layers during each main scanning operation in the forward direction and the backward direction. For this reason, it is possible to appropriately model the three-dimensional object 5 with high precision as regards the size in the lamination direction (Z direction), like the case of the usual mode. In this case, for example, it is thought that the inks of the modeling layer and the coloring layer are more likely to be mixed, as compared to the usual mode. For this reason, the operation of the high speed mode is an operation mode appropriate for a case where the modeling speed has priority over the quality.

Also, the three-dimensional object to be modeled may be required to have a higher quality than the case where the modeling is performed in the usual mode. In this case, in this illustrative embodiment where an operation of a high precision mode capable of performing the modeling with higher precision can also be performed, the high precision mode is an operation mode in which the main scanning operation in one direction (single direction), not the main scanning operations in both the directions (reciprocation), is performed and the modeling and the coloring are performed during the separate main scanning operations.

More specifically, for example, a configuration where only the main scanning operation in the same direction as the forward direction of the operation in the standard mode is performed and an ink layer of one layer in the lamination modeling method is formed during the two-times main scanning operations is also considered. In this case, like the ink layers formed in the case shown in FIG. 5A, for example, the modeling layer 402 and the support layer 404 are formed by the first main scanning operation and the flattening is performed by the roller 302 of the flattening roller unit 222 denoted with the reference numeral R1 in FIG. 4A. Also, during the second main scanning operation, the main scanning operation in the same direction as the first main scanning operation is performed, the outlying ink layer 406 including the coloring layer is formed to color the three-dimensional object 5, like the ink layers formed in the case shown in FIG. 5B, for example. Also during the second main scanning operation, the flattening is performed by the roller 302 of the flattening roller unit 222 denoted with the reference numeral R1 in FIG. 4A, like the first main scanning operation.

In the meantime, regarding the ultraviolet light sources 220, it is considered to turn on the light source UV1 all the time. The light source UV3 may be turned on or not, depending on the type of the ink, the texture required for the three-dimensional object 5, and the like.

According to the above configuration, since the ink layer of one layer in the lamination modeling method is formed by twice performing the main scanning operation in one direction, the operation speed is slower, as compared to the usual mode. However, for example, the ink mixing between the modeling layer and the coloring layer is difficult to occur, like the usual mode. Also, since the direction of the main scanning operation is always the same, it is thought that the precision (precision of the ejection position) of the spotting position of the ink in the main scanning direction is more favorable, as compared to the usual mode. For this reason, when the operation is performed in the high precision mode, it is possible to appropriately model the three-dimensional object of a higher quality, as compared to the usual mode. That is, the operation of the high precision mode is an operation mode appropriate for a case where the quality has priority over the modeling speed.

Also, it is considered to perform only the modeling without the coloring by using the apparatus 10 for modeling a three-dimensional object. In this case, an operation mode in which only the modeling is performed is considered.

More specifically, for example, it is considered to perform an operation of a high speed modeling mode, which is an operation mode in which only the modeling is performed at high speed. In this case, for example, the main scanning operation is performed in both the directions, i.e., the forward direction and the backward direction by using only the inkjet head for modeling. More specifically, it is considered to use at least the head 204 for modeling material as the inkjet head for modeling. Also, the head 206 for white ink, the head 208 for clear ink and the like may be further used as the inkjet head for modeling.

In the operation of the high speed modeling mode, the ink droplets are ejected from the inkjet head for modeling and the flattening is performed by the roller 302 of the flattening roller unit 222 denoted with the reference numeral R1 during the main scanning operation in the forward direction, for example. Also, during the main scanning operation in the backward direction, the ink droplets are ejected from the inkjet head for modeling.

Meanwhile, in the operation of the high speed modeling mode, since the heads 202y to k for coloring are not used, it is not necessary to consider the concerns that the inks are mixed upon the flattening. For this reason, the flattening may be collectively performed for the ink layer formed during the main scanning operation in the forward direction and the ink layer formed during the main scanning operation in the backward direction. For this reason, in the operation of the high speed modeling mode of this illustrative embodiment, for example, the flattening is performed only during the main scanning operation in the forward direction and the flattening during the main scanning operation in the backward direction is omitted.

Also, in this case, regarding the ultraviolet light sources 220, it is considered to turn on the light source UV1 all the time and not to turn on the light source UV2. The light source UV3 may be turned on or not.

By this configuration, for example, it is possible to appropriately model a non-colored three-dimensional object. Also, the modeling is performed at the higher speed than the high speed mode in the case where the coloring is made, because the ejection of the ink droplets by the heads 202y to k for coloring is not performed and the scanning is not required as for the flattening roller unit 222 denoted with the reference numeral R2 and the light source UV2.

Also, even when modeling a non-colored three-dimensional object, it may be required to perform the modeling with higher precision. For this reason, in this case, it is considered to perform an operation of a high precision modeling mode, which is an operation mode in which only the modeling is performed with high precision.

More specifically, in the operation of a high precision modeling mode, only the main scanning operation in one direction (single direction) is performed, like the operation of a high precision mode in the case where the coloring is made. More specifically, for example, only the main scanning operation in the forward direction is performed, the ink droplets are ejected from the inkjet head for modeling and the flattening is performed by the roller 302 of the flattening roller unit 222 denoted with the reference numeral R1. Also, in this case, regarding the ultraviolet light sources 220, it is considered to turn on the light source UV1 all the time and not to turn on the light source UV2. The light source UV3 may be turned on or not.

By this configuration, for example, it is possible to perform the modeling with high precision, like the operation of a high precision mode in the case where the coloring is made. Also, the modeling is performed at the higher speed than the high precision mode in the case where the coloring is made, because the ejection of the ink droplets by the heads 202y to k for coloring is not performed and the scanning is not required as for the flattening roller unit 222 denoted with the reference numeral R2 and the light source UV2.

As described above, according to the above configuration, the apparatus 10 for modeling a three-dimensional object of this illustrative embodiment can operate not only in the usual mode but also in the various operation modes. Thereby, it is possible to perform the modeling in the various operation modes, depending on the quality required for the three-dimensional object 5, and the like.

Also, the specific operations in the respective operation modes are not limited to the above-described operations and can be variously changed. For example, the operation in the usual mode can be modified as follows.

For example, during the operation in the usual mode, it is considered to set the rotating speeds to be the same for the rollers 302 of the pair of flattening roller units 222. By this configuration, it is possible to set the rotating speed of the roller 302 more simply.

However, in a modified embodiment of the configuration of the apparatus 10 for modeling a three-dimensional object, for example, it may be considered to make the rotating speeds different between the roller 302 of the one flattening roller unit 222 and the roller 302 of the other flattening roller unit 222 when performing the flattening. By this configuration, for example, it is possible to more appropriately set the rotating speeds of the respective rollers 302 in conformity to the configurations of the ink layers, which are formed during the main scanning operation in which the flattening is performed. Thereby, for example, it is also possible to more appropriately perform the flattening by using the settings corresponding to the configurations of the ink layers.

For example, it is considered to set the rotating speed of the roller 302, which is configured to flatten the color ink layer formed by the heads 202y to k for coloring, to be slower than the rotating speed of the roller 302, which is configured to flatten the modeling layer formed by the head 204 for modeling material and the like. More specifically, when performing the operation described with reference to FIGS. 4A and 4B and the like, it is considered to set the rotating speed of the roller 302 of the flattening roller unit 222 (the reference numeral R2), which is configured to perform the flattening during the main scanning operation in the backward direction, to be slower than the rotating speed of the roller 302 of the flattening roller unit 222 (the reference numeral R1), which is configured to perform the flattening during the main scanning operation in the forward direction.

By the above configuration, for example, it is possible to appropriately prevent the color ink, which is not cured yet, from flowing (creep) in the main scanning direction (Y direction). Thereby, it is also possible to appropriately suppress the blurring, which is caused as the ink of another color is mixed.

Also, in the operation described with reference to FIGS. 4A and 4B and the like, the roller 302 of the flattening roller unit 222 is configured to rotate in the direction denoted with an arrow in FIGS. 4A and 4B, for example. Thereby, when performing the flattening, the roller 302 is rotated so as to slide relative to the surface of the ink layer and to scrape the ink.

However, in order to suppress the blurring of the ink, it may be preferably to press and squash the ink layer for the flattening, not to scrub the ink layer by the roller 302. For this reason, the roller 302 may be configured to rotate in an opposite direction to the direction denoted with the arrow in FIGS. 4A and 4B and the like. Also, in this case, it is preferably to disable the flattening roller 302 from sliding relative to the ink layer by matching the moving speed of the inkjet head and the rotating speed of the roller 302 during the main scanning operation. Also, when generally describing this configuration, for example, it can be said that the rotating direction and rotating speed of the roller 302 of at least one flattening roller unit 222 are configured so that the outer periphery of the roller 302 does not slide at a contact position with the three-dimensional object being modeled.

Also, for example, only the flattening roller unit 222 (the reference numeral R2) configured to flatten the coloring layer may be configured so that the roller 302 thereof is rotated in the opposite direction to the direction denoted with the arrow in FIGS. 4A and 4B and the like. In this case, the rollers 302 of the pair of flattening roller units 222 are configured to rotate in the same direction. By this configuration, for example, it is possible to more appropriately flatten the coloring layer, in which the blurring is particularly problematic, by the method with which the blurring is difficult to occur. Also, in this case, the blurring is not problematic, and it is preferably to rotate the roller 302 in the direction denoted with the arrow in FIGS. 4A and 4B and the like so as to scrape the ink of the modeling layer, which is formed in the wider area than the coloring layer. By this configuration, it is possible to more appropriately flatten the modeling layer formed in the wide area.

Also, in the operation described with reference to FIGS. 4A, 4B, 5A and 5B, during the main scanning operation in the backward direction, the ink layers configuring the inner clear area 52, the coloring area 53 and the outer clear area 54 are formed as the outlying ink layer 406. However, when performing the operation in the usual mode of this illustrative embodiment, it is thought that the ink mixing between the inner white area 51 and the coloring area 53 is difficult to occur, even though the inner clear area 52 is not formed. For this reason, during the main scanning operation in the backward direction, the formation of the ink layer configuring the inner clear area 52 may be omitted. Also, during the main scanning operation in the backward direction, the formation of the ink layer configuring the outer clear area 54 may be omitted depending on the quality required for the three-dimensional object 5, and the like.

Also, as described above with reference to FIGS. 5A and 5B, according to the operation in the usual mode of this illustrative embodiment, the coloring layer is formed in the areas 506 having a recess shape formed during the main scanning operation in the forward direction, so that it is possible to appropriately prevent the position of the coloring layer from deviating and the coloring layer from being obliquely formed. When modeling the three-dimensional object, it can be said that the position precision of the coloring layer to be formed in the outlying area is most important. For this reason, it is preferably to form the ink layers in accordance with the sequence described above.

However, it is also considered to reverse the sequence of forming the ink layers, depending on the precision required for the three-dimensional object, the features of the three-dimensional object, and the like. Also in this case, for example, when the modeling layer and the coloring layer are respectively formed during the separate main scanning operations, it is possible to more appropriately prevent the ink for modeling and the ink for coloring from being mixed. Thereby, it is also possible to appropriately model the three-dimensional object with high precision.

Also, when generally describing the preferred operation as regards the method of forming the respective layers in accordance with the lamination modeling method, including the configuration of reversing the sequence of forming the ink layers, for example, it can be said that the main scanning operation in one direction (for example, the forward direction), which is first performed, is the first layer forming operation of forming one layer of the coloring layer and the modeling layer by using one of the head for coloring and the head for modeling. Also, it can be said that the main scanning operation in the other direction (for example, the backward direction), which is later performed, is the second layer forming operation of forming the other layer of the coloring layer and the modeling layer to be adjacent to the wall part of the one layer by using the other of the head for coloring and the head for modeling after curing the one layer.

In the meantime, regarding the above operation, when forming the coloring layer and the clear ink layer as the outlying ink layer 406, as described above with reference to FIGS. 5A and 5B and the like, the description ‘the other layer is formed to be adjacent to the wall part of the one layer’ with respect to the positional relation between the coloring layer and the modeling layer may include a configuration where the other layer is adjacent to the one layer with the clear ink layer being positioned therebetween, for example. Also, in this case, the outlying ink layer 406 including the coloring layer and the clear ink layer can be considered as the coloring layer in a broad sense.

Also, the flattening by the roller 302 may be performed at a state where the ink is preliminarily cured to a level at which the ink is capable of being removed by the roller 302, not the timing at which the ink is at a liquid state. In this case, for example, during each main scanning operation, the ink droplets may be ejected from the inkjet head positioned at the front of the light source UV3 and the ink may be preliminarily cured by the light source UV3. Also, after that, the ink layer may be flattened by the flattening roller unit 222 positioned at the rear of the light source UV3 and the ink may be fully cured by the ultraviolet light source 220 positioned at the rear of the flattening roller unit 222. By this configuration, for example, it is possible to cure and shrink the ink before the flattening. Thereby, it is also possible to prevent the size precision of the three-dimensional object from being lowered due to the influence of the curing shrinkage.

Also, when performing the flattening at a state where the preliminary curing has been made, it is considered to perform the ejection of the ink droplets and the ultraviolet irradiation for preliminary curing the ink during one main scanning operation and to perform the flattening and the ultraviolet irradiation for full curing during the next main scanning operation. More specifically, for example, it is considered to perform the ejection of the ink droplets and the preliminary curing operation for the modeling layer during the main scanning operation in the forward direction and to perform the flattening and the full curing operation for the modeling layer during the main scanning operation in the backward direction. Also, in this case, it is considered to perform the ejection of the ink droplets and the preliminary curing operation for the coloring layer at the same time as the operation during the main scanning operation in the backward direction. Also, it is considered to perform the flattening and the full curing operation for the coloring layer at the same time as the operation during the next main scanning operation in the forward direction. In this case, for example, it is preferably to perform the flattening by using the flattening roller unit 222 of the pair of flattening roller units 222, which is positioned at the front with respect to the moving direction of the main scanning operation. By this configuration, for example, it is possible to more appropriately flatten the ink layer preliminarily cured during the previous main scanning operation.

Also, in the illustrative embodiment, the configuration where the ejection unit 12 has the pair of (two) flattening roller units 222 has been described. However, the ejection unit 12 may have three or more flattening roller units 222. In this case, for example, the roller 302 of at least one flattening roller unit 222 of the plurality of flattening roller units 222 may be configured to rotate in the different direction from the rotating directions of the rollers 302 of the other flattening roller units 222. Also, the roller 302 of at least one flattening roller unit 222 of the plurality of flattening roller units 222 may be configured to rotate at the different speed from the rotating speeds of the rollers 302 of the other flattening roller units 222. Also, the roller 302 of at least one flattening roller unit 222 of the plurality of flattening roller units 222 may be configured to be moveable in a direction facing towards the three-dimensional object 5 from the ejection unit 12.

Although the illustrative embodiment of the present disclosure has been described, the technical scope of the present disclosure is not limited to the illustrative embodiment. It is obvious to one skilled in the art that the illustrative embodiment can be variously changed or improved. It is clear from the claims that the changes or improvements can also be included in the technical scope of the present disclosure.

### INDUSTRIAL APPLICABILITY

The present disclosure can be appropriately applied to the apparatus for modeling a three-dimensional object, for example.

What is claimed is:

1. An apparatus for modeling a three-dimensional object configured to model a three-dimensional object by a lamination modeling method, the apparatus comprising:
a head for coloring, which is an inkjet head configured to form an area of the three-dimensional object, which is to be colored with a predetermined color, by an ink for coloring;
a head for modeling, which is an inkjet head configured to form at least an inner area of the three-dimensional object;
at least a pair of flattening rollers configured to flatten the three-dimensional object being modeled, and
a main scanning driving unit configured to enable the head for coloring and the head for modeling to perform a main scanning operation of ejecting ink droplets while moving in a preset main scanning direction,
wherein the main scanning driving unit is configured to enable:
at least the head for modeling to perform the main scanning operation in a first direction, which is one side direction of the main scanning direction, and
at least the head for coloring to perform the main scanning operation in a second direction, which is the other side direction of the main scanning direction, and
wherein the one flattening roller of the pair of flattening rollers flattens the three-dimensional object being modeled when the main scanning operation in the first direction is performed, and
the other flattening roller of the pair of flattening rollers flattens the three-dimensional object being modeled when the main scanning operation in the second direction is performed.

2. The apparatus for modeling a three-dimensional object according to claim 1, wherein
the head for coloring and the head for modeling are configured to eject ink droplets of an ultraviolet curable ink, which is to be cured by ultraviolet irradiation.

3. The apparatus for modeling a three-dimensional object according to claim 1, further comprising:
a roller advance/retreat driving unit configured to advance and retreat each of the pair of flattening rollers in a direction facing towards the three-dimensional object,
wherein the roller advance/retreat driving unit is configured:
to arrange the one flattening roller of the pair of flattening rollers at an advanced position and to arrange the other flattening roller at a retreated position while the main scanning operation in the first direction is performed, and
to arrange the other flattening roller at an advanced position and to arrange the one flattening roller at a retreated position while the main scanning operation in the second direction is performed.

4. The apparatus for modeling a three-dimensional object according to claim 3, wherein
the roller advance/retreat driving unit is configured:
to advance the flattening roller, thereby bringing the flattening roller close to the three-dimensional object being modeled, and
to retreat the flattening roller, thereby separating the flattening roller from the three-dimensional object being modeled.

5. The apparatus for modeling a three-dimensional object according to claim 1, wherein
during the main scanning operation in the first direction, the main scanning driving unit is configured to enable only the head for modeling of the head for modeling and the head for coloring to eject the ink droplets and the one flattening roller is configured to flatten an ink layer formed by the head for modeling, and
wherein during the main scanning operation in the second direction, the main scanning driving unit is configured to enable only the head for coloring of the head for modeling and the head for coloring to eject the ink droplets and the other flattening roller is configured to flatten an ink layer formed by the head for coloring.

6. The apparatus for modeling a three-dimensional object according to claim 1, wherein
during the main scanning operations in the first direction and the second direction, the main scanning driving unit is configured to enable both the head for modeling and the head for coloring to eject the ink droplets.

7. The apparatus for modeling a three-dimensional object according to claim 1, wherein
the one flattening roller and the other flattening roller are configured to rotate in different rotating directions during the flattening.

8. The apparatus for modeling a three-dimensional object according to claim 1, wherein
the one flattening roller and the other flattening roller are configured to rotate at different rotating speeds during the flattening.

9. The apparatus for modeling a three-dimensional object according to claim 1, wherein
the one flattening roller is arranged at one side in the main scanning direction with respect to the head for coloring and the head for modeling,
wherein the other flattening roller is arranged at the other side in the main scanning direction with respect to the head for coloring and the head for modeling, and
wherein during each of the main scanning operations in the first direction and the main scanning operation in the second direction, the flattening roller positioned at the rear with respect to the head for coloring and the head for modeling is configured to flatten the three-dimensional object being modeled.

10. The apparatus for modeling a three-dimensional object according to claim 1, wherein
the apparatus is configured to form a layer comprising a coloring layer, which is an ink layer to be formed by the head for coloring, and a modeling layer, which is an ink layer to be formed by the head for modeling, as each layer to be formed by the lamination modeling method, and
wherein upon the formation of each layer, the apparatus is configured to perform:
a first layer forming operation of forming one layer of the coloring layer and the modeling layer by using one of the head for coloring and the head for modeling, and
a second layer forming operation of forming the other layer of the coloring layer and the modeling layer to be adjacent to a wall part of the one layer by using the other of the head for coloring and the head for modeling after curing the one layer.

11. The apparatus for modeling a three-dimensional object according to claim 1, further comprising:
a head for support layer, which is an inkjet head configured to form a support layer configured to support a periphery of the three-dimensional object being modeled,
wherein the apparatus is configured to form a layer comprising a coloring layer, which is an ink layer to be formed by the head for coloring, a modeling layer, which is an ink layer to be formed by the head for modeling, and the support layer, which is an ink layer to be formed by the head for support layer, as each layer to be formed by the lamination modeling method,
wherein upon the formation of each layer, the apparatus is configured to perform:
a first layer forming operation of forming the modeling layer and the support layer by using the head for modeling and the head for support layer, and
a second layer forming operation of forming the coloring layer by using the head for coloring after the first layer forming operation,
wherein during the first layer forming operation, the modeling layer and the support layer are formed so as to sandwich an area, in which the coloring layer is later to be formed, between the modeling layer and the support layer, so that a wall part of the modeling layer is formed at one side of the area in which the coloring layer is to be forming and a wall part of the support layer is formed at the other side of the area in which the coloring layer is to be formed, and
wherein during the second layer forming operation, the coloring layer is formed between the wall part of the modeling layer and the wall part of the support layer.

12. An apparatus for modeling a three-dimensional object configured to model a three-dimensional object by a lamination modeling method, the apparatus comprising:
a head for coloring, which is an inkjet head configured to form an area of the three-dimensional object, which is to be colored with a predetermined color, by an ink for coloring;
a head for modeling, which is an inkjet head configured to form at least an inner area of the three-dimensional object;
at least a pair of flattening rollers configured to flatten the three-dimensional object being modeled, and
a main scanning driving unit configured to enable the head for coloring and the head for modeling to perform a main scanning operation of ejecting ink droplets while moving in a preset main scanning direction,
wherein one flattening roller of the pair of flattening rollers is arranged at one side in the main scanning direction with respect to the head for coloring and the head for modeling,
wherein the other flattening roller of the pair of flattening rollers is arranged at the other side in the main scanning direction with respect to the head for coloring and the head for modeling,
wherein the main scanning driving unit is configured to enable:
at least the head for modeling to perform the main scanning operation in a first direction, which is one side direction of the main scanning direction, and
at least the head for coloring to perform the main scanning operation in a second direction, which is the other side direction of the main scanning direction, and
wherein during each of the main scanning operations in the first direction and the main scanning operation in the second direction, the flattening roller positioned at the rear with respect to the head for coloring and the head for modeling is configured to flatten the three-dimensional object being modeled.

13. A method for modeling a three-dimensional object by a lamination modeling method, the method using:
a head for coloring, which is an inkjet head configured to form an area of the three-dimensional object, which is to be colored with a predetermined color, by an ink for coloring;
a head for modeling, which is an inkjet head configured to form at least an inner area of the three-dimensional object, and
at least a pair of flattening rollers configured to flatten the three-dimensional object being modeled,
the method comprising enabling the head for coloring and the head for modeling to perform a main scanning operation of ejecting ink droplets while moving in a preset main scanning direction,
wherein when controlling the main scanning operation, the method comprises enabling:
at least the head for modeling to perform the main scanning operation in a first direction, which is one side direction of the main scanning direction, and
at least the head for coloring to perform the main scanning operation in a second direction, which is the other side direction of the main scanning direction, and
wherein the method comprises flattening the three-dimensional object being modeled by the one flattening roller of the pair of flattening rollers when the main scanning operation in the first direction is performed, and flattening the three-dimensional object being modeled by the other flattening roller of the pair of flattening rollers when the main scanning operation in the second direction is performed.
